(19) United States
(12) Patent Application Publication
(10) Pub. No.: US 2026/0293941 A1
(43) Pub. Date: Oct. 1, 2026

(54) PROCESS FOR AN INSTANT FRIED NOODLE

(71) Applicant: SOCIETE DES PRODUITS NESTLE S.A., Vevey (CH)

(72) Inventors: OM PRAKASH SINGH, Bihar (IN); AMARINDER PAL SINGH BHANDARI, Harayana (IN); ASHWINI KUMAR SHARMA, Moga (IN); SUKHPAL SINGH, Punjab (IN)

(21) Appl. No.: 18/874,152

(22) PCT Filed: Jun. 7, 2023
(86) PCT No.: PCT/EP2023/065289

§ 371 Date: Dec. 12, 2024

(30) Foreign Application Priority Data
Jun. 13, 2022 (IN) 202211033829
Aug. 3, 2022 (EP) 22188473.7

(51) Int. Cl. A23L 7/113; A23L 5/10

(52) U.S. Cl. CPC A23L 7/113; A23L 5/11; A23L 5/13

(57) ABSTRACT

The present invention relates to a process for the production of a packed instant fried noodle cake. In particularly the invention relates to a process for the production of a packed instant fried noodle cake wherein the noodle cake is not folded or molded after cutting.

The present invention relates to a process for the production of a packed instant fried noodle cake. In particularly the invention relates to a process for the production of a packed instant fried noodle cake wherein the noodle cake is not folded or molded after cutting.

It is already known to have a packed instant fried noodle cake, wherein the noodle cake is folded to a 2 layered noodle cake having a density between 0.20 to 0.25 g/cm³.

The process for the production of a packed instant fried noodle cake, wherein the noodle cake is not folded is leading to benefits on reduced chippings/waste generation while the noodle cakes are passed through a packaging machine due to an increased cake strength. The higher density of the noodle cake obtained by not folding the noodle cake is enabling packaging of the instant fried noodle cake with reduced quantity of packaging material compared to standard noodle cakes. Additionally, the higher density of the noodle cake has a positive impact during the frying process. A standard noodle cake is folded to a 2 layered noodle cake and has approximately 6% higher oil content in the bottom layer as compared with the top layer, leading to overall higher fat/oil content. The increased density of the single layered noodle cake has a significant positive impact in the frying process with reduced fat/oil content in the final product by approximately 10%, eliminating the difference of fat/oil content between the top and bottom layer of folded noodle cakes having a density between 0.20 to 0.25 g/cm³. Therefore surprisingly, the new manufacturing process also reduced the total fat/oil uptake in fried instant noodles.

### SUMMARY OF THE INVENTION

The object of the present invention is to improve the state of the art and to provide an improved or at least an alternative solution to overcome at least some of the inconveniences described above. The object of the present invention is achieved by the subject matter of the independent claims. The dependent claims further develop the idea of the present invention.

Accordingly, the present invention provides in a first aspect a process for the production of a packed instant fried noodle cake comprising the steps of:
a) Mixing flour and other dry ingredients with Kansui salts to form an uniform dough;
b) Sheeting and slitting the dough to obtain noodle strands;
c) Steaming the noodle strands from step b);
d) Cutting the noodle strands from step c) to obtain a noodle cake;
e) Pre-drying to remove moisture before frying;
f) Frying the noodle cake from step d) or e) in fat or oil;
g) Cooling;
h) Wrapping the cooled noodle cake with a packaging material;
   wherein the noodle cake is not folded or molded after cutting.

It has been surprisingly found by the inventors, that by using a process for the production of a packed instant fried noodle cake wherein the noodle cake is not folded after cutting reduces chippings/waste generation while the noodle cakes are passed through a packaging machine. Overall, the higher product density is enabling packaging of the product with reduced quantity of packaging material. Additionally, the not folded noodle cake has a positive impact during the frying process. A standard noodle cake is folded to a 2 layered noodle cake and has approximately 6% higher oil content in the bottom layer as compared with the top layer, leading to overall higher fat/oil content. The increased density of the single layer noodle cake has a significant positive impact in the frying process with reduced fat/oil content in the final product by approximately 10%, eliminating the difference of fat/oil content between the top and bottom layer of folded noodle cakes having a density between 0.20 to 0.25 g/cm³. Therefore, it was surprisingly found that the new manufacturing process of a not folded noodle cake also reduce the fat/oil uptake in fried instant noodles to obtain minimum 10% fat/oil reduction vs conventionally fried folded noodles.

### DETAILED DESCRIPTION OF THE INVENTION

The present invention pertains in a first aspect to a process for the production of a packed instant fried noodle cake comprising the steps of:
a) Mixing flour and other dry ingredients with Kansui salts to form an uniform dough;
b) Sheeting and slitting the dough to obtain noodle strands;
c) Steaming the noodle strands from step b);
d) Cutting the noodle strands from step c) to obtain a noodle cake;
e) Pre-drying to remove moisture before frying;
f) Frying the noodle cake from step d) or e) in fat or oil;
g) Cooling;
h) Wrapping the cooled noodle cake with a packaging material;
   wherein the noodle cake is not folded or molded after cutting.

In a preferred aspect the present invention pertains to a process for the production of a packed instant fried noodle cake comprising 45 to 80 wt % of flour (by weight of the total composition), 0.2 to 3.5 wt % of Kansui salts (by weight of the total composition), 0 to 7 wt % of wheat gluten (by weight of the total composition), 0 to 20 wt % of starch (by weight of the total composition) and 10 to 30 wt % of fat or oil (by weight of the total composition), the process comprising the steps of:
a) Mixing flour and other dry ingredients with Kansui salts to form an uniform dough;
b) Sheeting and slitting the dough to obtain noodle strands;
c) Steaming the noodle strands from step b);
d) Cutting the noodle strands from step c) to obtain a noodle cake;
e) Pre-drying to remove moisture before frying;
f) Frying the noodle cakes from step d) or e) in fat or oil;
g) Cooling;
h) Wrapping the cooled noodle cake with a packaging material;
   wherein the noodle cake is not folded or molded after cutting.

The present invention pertains in a second aspect to a method for reducing the uptake of fat/oil of at least 10% of a packed instant fried noodle cake as claimed in any one of claims 1 to 13 compared to a folded 2 layer noodle cake.

The term “noodle cake” according to this invention means noodles, which are formed and cut into a suitable lengths of the required shape. The dimensions of the noodle cakes are chosen to give a cake which may weigh from about 20 to 250 g, preferably from about 20 to 150 g, more preferably from 25 to 100 g.

The term “flour” according to this invention means a flour used to prepare a noodle dough. In an embodiment flour means at least one ingredient of wheat flour, oat flour, corn flour, rice flour, barley flour, lentil flour, pulses flour, ancient grain flour, millet flour or combinations thereof, preferably wheat flour. The flour has a particle size of 50 to 400 μm. A finer particle size could mean a high chance of starch to be damaged in the flour leading to higher water absorption. The dough would become sticky and causes operation issues. In addition, noodle would turn sticky, starchy and non-elastic. A flour with a large particle size, on the other hand, needs longer water absorption time and often forms large dough lumps. In an embodiment the flour is standard refined wheat flour. In an embodiment the dried noodle cake comprises 45 to 80 wt % of flour (by weight of the total composition), preferable 48 to 80 wt %, preferably 50 to 75 wt %, preferably 52 to 72 wt % (by weight of the total composition).

The term “kansui salts” comprises a mixture of alkaline salts comprising sodium chloride, sodium carbonate, potassium carbonate and sodium phosphate. In an embodiment the noodle cake comprises 0.2 to 3.5 wt % of kansui salts (by weight of the total composition). In a preferred embodiment the kansui salts are dissolved in water to obtain a kansui solution. The term “kansui solution” comprises a mixture of 1 to 15 wt % of alkaline salts comprising sodium chloride, sodium carbonate, potassium carbonate and sodium phosphate (based on the total amount of the solution) in 85 to 99 wt % of water (based on the total amount of the solution), preferably the kansui solution comprises 3 to 7 wt % of alkaline salts and 93 to 97 wt % of water (based on the total amount of the solution).

The dough mixing time is between 10 to 40 minutes, preferably 15 to 30 minutes. A twin speed mixer is used. The mixing speed is between 50 to 120 rpm. High speed mixing (between 100 to 120 rpm) is recommended during the time the kansui solution is dosed to avoid localized dosing and to ensure homogeneity. For addition of small ingredients like calcium carbonate, fortificant (vitamin and/or mineral) it is recommended to make a pre-blend with noodle flour before addition. The amount of water added has a big influence on dough formation. The moisture content of the dough after mixing should be between 20 to 40%, preferably between 25 to 35%. If too much water is added the dough will be too soft and sticky. If too less water is added the noodle will be brittle, doughy and hard-centered due to insufficient gelatinisation during steaming as degree of gelatinisation depends on moisture content of dough.

The term “sheeting” is a process step wherein the dough is passed through a series of rollers to obtain a final sheet of desired thickness which will then determine the noodle strand thickness. By sheeting the dough a network is developed as pressure is applied. In addition, the sheeting removes entrapped air from the dough and therefore reduces porosity and result in less oil uptake.

The slitter/cutter called “kiriha” consists of a pair of grooved cylinders which cut and separate the dough sheet into strands that are trapped in the grooves. These strands are immediately removed by a comb-like scraper, called “kasuri” which is attached in between the two rollers. The width of the noodle strand is determined by Kiriha groove width.

The purpose of steaming is to gelatinize the starch in order to eliminate the raw and doughy taste on the end-product. Steaming time and temperature along with steam pressure affect product quality and are known to the person skilled in the art. Good steaming results to obtain at least 80% starch gelatinisation is giving a better association of starch granules and protein matrix as well as better continuity of protein network. The steaming time is between 0.5 to 15 minutes, preferably 0.5 to 7 minutes. A saturated steam is used. If steaming is insufficient, the final noodle will have a gritty center, doughy and raw wheat after taste (cereal note). Noodle strands coming out of the steamer are hot and tend to stick to the steamer mesh conveyor. This can lead to poor cutting and folding down the line. Therefore, the strands are cooled and slightly dried up using fans or blowers/air knives at the exit of steamer tunnel.

Cutting occur after steaming the noodle strands. Cutting means that the noodle strands are cut to a desired length. At this stage, the noodle is still quite flexible but is able retain its shape

Pre-drying is used to reduce the wet cake moisture content by 2 to 10%. In addition, after pre-drying an oil up take reduction by 1 to 8%, preferably 2 to 4% is achieved. A pre-drying step is done at a temperature between 50 to 120° C. within 15 to 500 sec, preferably at a temperature between 60 to 100° C. within 30 to 400 sec.

Frying is a process wherein moisture from cakes is removed to a desired level and doughy taste is eliminated in the end product. Steamed or pre-dried noodle cakes are conveyed to the fryer buckets which pass through the hot oil bath. The Frying in fat or oil is done at temperatures between 110 to 170° C. and a frying time between 30 to 200 seconds, preferably at temperatures between 130 to 165° C. and a frying time between 40 to 150 seconds. After fat or oil frying the final moisture in the product is less than 10 wt %, preferably between 2 to 10 wt % (by weight of the total composition). The final product has a water activity<0.6. Preferably the frying is done with palm oil, sunflower oil, high oleic oils, high oleic sunflower oil, ground nut oil, rice bran oil, mustard oil, soybean oil or a combination thereof, preferably palm oil or high oleic sunflower oil or combination thereof.

In an embodiment the fried noodle cake has an amount of fat or oil in the range of 10 to 30 wt % (by weight of the total composition), preferably between 10 to 25 wt %, preferably between 10 to 20 wt %, preferably between 12 to 25 wt %, preferably between 12 to 19 wt %, preferably between 12 to 15 wt % (by weight of the total composition). In a preferred embodiment no fat or oil is mixed to the flour and other dry ingredients with Kansui salts to form an uniform dough. The amount of fat or oil of the noodle cake is achieved only by frying the noodle cake in fat or oil.

Cooling means that the temperature of the noodle cake after frying is reduced. It is desirable to have the noodle cake temperature the same as or close to room temperature before wrapping, preferably between 20 to 30° C., more preferably between 20 to 25° C. Otherwise, there may be condensation of water vapour in the packet of noodles, which may lead to mould growth. A side from condensates, hot cakes also cause expansion of air within the pack, subsequently causing difficulty in secondary packaging.

The term “packaging material” refers to a plastic film and/or paper film. In an embodiment of the invention the packaging material comprises a printed metallized plastic film and/or a printed paper based film.

In an embodiment the noodle cake has a rectangular form.

In an embodiment the fried noodle cake has a density between 0.27 to 0.39 g/cm³, preferably between 0.28 to 0.39 g/cm³, preferably between 0.29 to 0.39 g/cm³, preferably between 0.30 to 0.39 g/cm³, preferably between 0.31 to 0.39 g/cm³, preferably between 0.28 to 0.38 g/cm³, preferably between 0.28 to 0.37 g/cm³, preferably between 0.28 to 0.36 g/cm³, preferably between 0.29 to 0.38 g/cm³, preferably between 0.29 to 0.37 g/cm³, preferably between 0.29 to 0.36 g/cm³, preferably between 0.30 to 0.38 g/cm³, preferably between 0.30 to 0.37 g/cm³, preferably between 0.30 to 0.36 g/cm³. The density is calculated: density=weight (g)/volume (cm3).

The noodle cake maybe fried in palm oil due its low cost, ease of availability and high oxidative stability. Nevertheless, consumers are increasingly becoming sensitive to palm oil or palm fat concerns. Many of them perceive palm fat as not healthy due to high amounts of saturated fatty acids (SFA) and many others perceive it as not environmentally sustainable as a lot of news mention that the rain forest is destroyed to grow palm trees. Therefore, in order to provide nutritional benefits, reduction of total fat and/or SFA content in the product is of considerable importance. It is hence essential to explore also other vegetable oils for frying of noodles which are not only economical to produce and easy to handle but are also stable for frying purposes. It should make noodles healthier without compromising on the sensory attributes, and overall quality of the product. In addition, it should also have lower values of process contaminants formed during refining of oils, i.e. glycidyl fatty acid esters (GE)<1 ppm (preferably <0.5 ppm) and 3-MCPD<3 ppm. A suitable oil, for frying comprises the fatty acids C16:0 in the range of 1 to 25 wt % (based on weight of total fat) and C18:1 in the range of 60 to 90 wt % (based on weight of total fat) and C18:2 in the range of 0.1 to 20 wt % (based on weight of total fat) is a high oleic sunflower oil. In an embodiment the oil comprises C16:0. C16:0 is palmitic acid. In a further embodiment C16:0 is in the range of 1 to 25 wt % (based on weight of total fat), preferably C16:0 is in the range of 1 to 20 wt % (based on weight of total fat), preferably C16:0 is in the range of 1 to 15 wt % (based on weight of total fat), preferably C16:0 is in the range of 1 to 10 wt % (based on weight of total fat), more preferably C16:0 is in the range of 2 to 7 wt % (based on weight of total fat). In an embodiment the oil comprises C18:1. C18:1 is oleic acid. In a further embodiment C18:1 is in the range of 60 to 90 wt % (based on weight of total fat), preferably C18:1 is in the range of 65 to 90 wt % (based on weight of total fat), preferably C18:1 is in the range of 70 to 90 wt % (based on weight of total fat), preferably C18:1 is in the range of 75 to 90 wt % (based on weight of total fat), more preferably C18:1 is in the range of 80 to 90 wt % (based on weight of total fat). In an embodiment the oil comprises C18:2. C18:2 is linoleic acid. In a further embodiment C18:2 is in the range of 0.1 to 20 wt % (based on weight of total fat), preferably C18:1 is in the range of 0.1 to 15 wt % (based on weight of total fat), preferably C18:1 is in the range of 0.1 to 10 wt % (based on weight of total fat), preferably C18:1 is in the range of 0.5 to 10 wt % (based on weight of total fat), more preferably C18:1 is in the range of 0.5 to 5 wt % (based on weight of total fat). In an embodiment the oil of this invention has a melting point of −1 to +5° C. and relative density of 0.91. It is preferred that the oil is liquid at room temperature (20° C.) to avoid unnecessary heating during storage and transfer of oil into the process, higher storage temperature of oil would already lead to oxidation of oil. Standard commercial available sunflower oil comprising the fatty acids C16:0 in the range of 5 to 8 wt % (based on weight of total fat) and C18:1 in the range of 14 to 40 wt % (based on weight of total fat) and C18:2 in the range of 48 to 74 wt % (based on weight of total fat). Standard commercial available palm oil comprising the fatty acids C16:0 in the range of 39 to 47 wt % (based on weight of total fat) and C18:1 in the range of 36 to 44 wt % (based on weight of total fat) and C18:2 in the range of 9 to 12 wt % (based on weight of total fat). In an embodiment the standard palm oil has a slip melting point between 30 to 50° C. and is solid at room temperature (20° C.).

In an embodiment the noodle cake is not folded or molded after cutting. In a cutting and mold technology, the steamed noodle mass is necessarily passed through a water/liquid seasoning shower by a method dipping/spraying/immersing of water to separate the noodle strands/wires from each other. This helps to loose the noodle mass. This loosened noodle mass is then stretched before being cut into small sizes. The cut noodle mass is then dropped into molding containers where the desired shape of the noodle cake is achieved. This molding process helps to achieve different level of density of the noodle cake/noodle mass however this technology leads to higher fat noodles and product attributes are different. In a preferred embodiment no pressurized gas is injected before frying the noodle cake. Not molding the noodle cake simplifies the process of the invention.

Those skilled in the art will understand that they can freely combine all features of the present invention disclosed herein. In particular, features described for different embodiments of the present invention may be combined. Where known equivalents exist to specific features, such equivalents are incorporated as if specifically referred to in this specification.

### EXAMPLES

### Example 1: Process of an Instant Fried Noodle Cake

The noodle manufacturing process involves mixing of flour (wheat flour) and kansui solution in a batch mixer. Noodle line used for the production is from CCK supplier. Dough from mixer is passed through rollers to form two sheets thereafter compounding the two dough sheets into one, reducing dough sheet to a desired thickness through a series of rollers. The final sheet is passed through the kiriha to slit the dough sheet and form the noodle strands, which are then steamed in a tunnel. The steamed noodles are cut and transferred into pre-dryer (without folding) to obtain a single layer noodle cake. The pre-dryer removes moisture before frying and helps to reduce the oil uptake. The pre-dried noodle cakes are discharged from pre-dryer to frying bucket, which are then passed through a fryer where noodle cakes are fried, and moisture is removed. After which, the cakes are cooled to ambient temperature before packing.

Below table shows details of all the process steps with the process parameters:

| Process Steps | Process Parameters | Moisture |
|---|---|---|
| Mixing | High Speed: 90 Hz, | 30-31% |
| | 1 min Dry Mixing | |
| | High Speed: 90 Hz, | |
| | 4 min Kansui Dosing | |
| | Low Speed: 50 Hz, | |
| | 16 minute for gluten development | |
| Sheeting & | Final Sheet Thickness: 0.9 mm, | |
| Slitting | Kiriha K 30 | |
| Steaming | Time: 130 s, Saturated Steam | 32-33% |
| Cut | Bag type | |
| Predrying | Temp: 80° C., Time: 225 s | 26-28% |
| Frying | Temp: 150°C, Time: 70 s, | 2-6% |
| | Oil Uptake: 18-19% | |
| Cooling | Ambient temperature a | 2-6% |
| | nd Packaging | |

### Density Measurement:

Dimensions of noodle cake is measured from three dimensions, each dimension is measured three times and the average is taken for volume calculation. The product is weight. The density is calculated: density=weight (g)/volume (cm3). Five products are used and the average density is reported.

### Examples 2-3

Examples 3 is prepared according to example 1. Comparison example 2 has an additional processing step of folding the noodle cake to a two-layer noodle cake as commercially available Maggi product.

| | Comp. Ex 2 | Ex. 3 |
|---|---|---|
| | Folded noodle cake | Unfolded noodle cake |
| | (2 layers) | (single layer) |
| Wheat flour | 76 | 76 |
| Kansui | 23 | 23 |
| Wheat gluten | 1 | 1 |
| Oil used for oil frying | HOSO | HOSO |
| Oil in final | 16% | 13.5% |
| instant noodle | | |
| Cake weight [g] | 32 | 32 |
| Length [mm] | 80 | 90 |
| Width [mm] | 65 | 65 |
| Height [mm] | 26 | 16 |
| Cake volume [cm³] | 135.2 | 93.6 |
| Cake density [g/cm³] | 0.237 | 0.342 |
| Cake breakage | | 20% reduction |
| by packaging | | compared |
| | | to comp. ex. 2 |

Example 3 has an increased density of 45% compared to comparison example 2. This increased density leads to a 20% reduction of breakage during packaging due to an increased cake strength. In addition, the amount of total fat after frying the noodle cake is reduced in example 3. Due to the reduced cake volume packaging material for wrapping the noodle cake can be reduced in example 3.

1. A process for the production of a packed instant fried noodle cake comprising the steps of:
a) Mixing flour and other dry ingredients with Kansui salts to form an uniform dough;
b) Sheeting and slitting the dough to obtain noodle strands;
c) Steaming the noodle strands from step b);
d) Cutting the noodle strands from step c) to obtain a noodle cake;
e) Pre-drying to remove moisture before frying;
f) Frying the noodle cake;
g) Cooling; and
h) Wrapping the cooled noodle cake with a packaging material;
wherein the noodle cake is not folded or molded after cutting.

2. A process for the production of a packed instant fried noodle cake as claimed in claim 1, wherein the flour is selected from the group consisting of wheat flour, oat flour, corn flour, rice flour, barley flour, millet flour and combinations thereof.

3. A process for the production of a packed instant fried noodle cake of claim 1, wherein the weight of the flour is in the range of 47 to 80 wt % by weight of the total composition.

4. A process for the production of a packed instant fried noodle cake of claim 1, wherein the kansui salts comprises a mixture of sodium chloride, sodium carbonate, potassium carbonate and sodium phosphate.

5. A process for the production of a packed instant fried noodle cake of claim 1, wherein the weight of the kansui salts are in the range of 0.2 to 3.5 wt % by weight of the total composition.

6. A process for the production of a packed instant fried noodle cake of claim 1, wherein the kansui salts are added as a solution of 1 to 10 wt % of sodium chloride, sodium carbonate, potassium carbonate and sodium phosphate based on the total amount of the solution in 90 to 99 wt % of water based on the total amount of the solution.

7. A process for the production of a packed instant fried noodle cake as claimed in claim 1, wherein the weight of the oil is in the range of 10 to 30 wt % by weight of the total composition.

8. A process for the production of a packed instant fried noodle cake as claimed in claim 1, wherein the instant noodle is fried in the oil at a temperature between 110 to 170° C. and a frying time between 30 to 200 seconds.

9. A process for the production of a packed instant fried noodle cake as claimed in claim 1, wherein the steaming is done by using saturated steam within 0.5 to 15 min.

10. A process for the production of a packed instant fried noodle cake as claimed in claim 1, wherein the pre-drying is done at a temperature between 50 to 120° C. and 15 to 500 sec.

11. A process for the production of a packed instant fried noodle cake as claimed in claim 1, wherein the noodle cake is a single layer noodle cake.

12. A process for the production of a packed instant fried noodle cake as claimed in claim 1, wherein the noodle cake has a density between 0.29 to 0.37 g/cm³.

13-14. (canceled)
